(19) United States
(12) Patent Application Publication
(10) Pub. No.: US 2003/0018533 A1
(43) Pub. Date: Jan. 23, 2003

(54) Method for providing golf courses with flags decorated with advertising

(76) Inventor: Ronald B. Klein, Yorktown Heights, NY (US)

Correspondence Address: ST. ONGE STEWARD JOHNSTON & REENS, LLC, 986 BEDFORD STREET, STAMFORD, CT, 06905-5619, US

(21) Appl. No.: 09/907,300

(22) Filed: Jul. 17, 2001

(51) Int. Cl. G06F 17/60

(52) U.S. Cl. 705/20

(57) ABSTRACT

A method includes providing a golf course with flags decorated with advertising from multiple advertisers, who are willing to purchase the rights to place their advertising on flags marking holes on the golf course in return for submitting funds to the golf course.

### FIELD OF THE INVENTION

This invention relates generally to a method for matching advertisers of products and services to an advertising medium including golf courses. More particularly, it pertains to method and system for providing golf courses with equipment in return for allowing the advertisers to use golf course equipment, such as flags identifying holes on the golf course, as an advertising medium.

### BACKGROUND OF THE INVENTION

The cornerstone of a free trade system is the ability of merchants to make the availability of their products and services known to potential purchasers. A fundamental need of sellers of merchandise and providers of services is an effective means for communicating product and services information to potential buyers. As evidenced by the thriving advertising industry, effective and persuasive means for communicating information to buyers is a paramount concern for providers.

The advent of broadcast media provided a revolutionary step and improvement in the ability to disseminate information to purchasers. Although radio and television have made it easier for a seller to distribute product and service information to a broader audience than traditional print media, they have not provided a highly effective means for targeting the receivers of the information.

Because of the broadcast media's ability to disseminate information in a rather scattered manner to parties who may or may not have a need for the advertised product or service, consumers are regularly bombarded with information from sellers that is of no interest or diluted by a mass of various and often conflicting advertising information, which in many cases serves only to irritate.

The more focused approach includes the practice of applying licensed trademarks to a variety of products, which is a common advertising strategy in the entertainment and sports industries. This approach has become increasingly successful, and it is now rather customary to see a sports arena named after its sponsor, such as the Continental Airlines Arena, or have billboards decorated with a variety of advertisements. Golf courses often have holes sponsored by advertisers whose names can be seen at tee areas, whereas flags marking the holes sometimes carry names of golf or country clubs.

Advertisers continue to look for new opportunities and methods for maintaining and further developing the public awareness and interest in the properties and trademarks. As an example, sports and entertainment logos are a common decorative element on clothing or luggage.

It is, therefore, desirable to provide a business method of matching multiple advertisers to a golf course that offers its accessories as an advertising medium to advertisers in return for receiving the accessories, such as flags, carts, etc. from the advertisers.

### SUMMARY OF THE INVENTION

This is obtained by an inventive method for facilitating matching between advertisers and advertising medium including such accessories of a golf course as the flags marking golf holes. The inventive method allows a flag provider or business administrator to select at least one golf course, gather necessary golf-course information, which among others includes a number of holes, and sell the rights to place advertisements on flags to multiple advertisers.

As a consequence, the golf course receiving a percentage of funds paid to the business administrator by advertisers can use these funds for any purpose, such as to improve and maintain the quality of the course and its accessories. Furthermore, the inventive method provides the advertisers with a new and highly visible advertisement medium, such as golf course flags which will be decorated with advertisements. Finally, the flag provider, creating financial incentives for both golf courses, whether public, semi-private or private with amateur or professional players, and advertisers, provides a financial opportunity for himself. By matching multiple advertisers to the holes on the golf course, the business administrator provides a valuable service funded by the advertisers.

In accordance with another aspect of the invention, the flag provider or advertiser selects golf courses in accordance with the specific information provided by participating golf courses. The presence of advertisements on golf courses may be contingent on certain requirements, which the golf courses submit to the business administrator. As an example, a prospective pool of golf courses or local laws may expressly exclude alcohol companies, tobacco companies, gun manufacturers or any other types of advertisers. The flag provider matches advertisers to holes applying a criterion based on geographical locations, climatic conditions, golf course parameters and the like specified by the advertiser, or the advertiser may select the courses based on the course information provided by the flag provider.

In accordance with another aspect of the invention, the inventive method can be practiced by a flag provider using an automated system. The system is capable of receiving information from a golf course and information from advertisers that is indicative of their requirements. The system may be computerized to match golf course holes to participating advertisers and provide a flag provider or system administrator with information containing the advertisement that will eventually decorate flags placed in the holes on the golf course. To fully equip a golf course, the flag provider utilizing the system can match multiple advertisers, who receive a right to display their advertisement on specific golf hole flags, to the golf course.

In accordance with one aspect of the invention, the flag provider uses the system to communicate with golf courses and advertisers through a communication link including telephone or the Internet.

In accordance with another aspect of the invention, the flag provider using the system is able to identify multiple advertisers who want to purchase rights to place their advertisement on a flag marking the same hole on the golf course. In this case, the system provides the advertisers with a bidding opportunity.

It is therefore an object of the invention to provide a method for facilitating the matching between multiple advertisers and a golf course which allows the advertisers to use golf course hole flags as an advertising medium in return for providing flags to the golf course.

Another object of the invention is to provide a method for providing golf courses with flags decorated with advertising, which is associated with multiple advertisers, at no cost to the golf courses.

Yet another object of the invention is to provide a method for selecting multiple advertisers willing to purchase the rights to use flags identifying the holes on a golf course as an advertising medium.

Still another object of the invention is to provide a system for automating the inventive method.

### BRIEF DESCRIPTION OF THE DRAWINGS

These and other objects, features and advantages will become more readily apparent from the following detailed description of the preferred embodiment accompanied by the drawings, in which:

FIG. 1 is a flowchart illustrating a method in accordance with the invention.

FIG. 2 is a flowchart illustrating one embodiment of collecting course information in accordance with the method shown in FIG. 1.

FIG. 3 is a flowchart illustrating one embodiment of collecting advertiser information in accordance with the method shown in FIG. 1.

FIG. 4 is a flowchart illustrating one embodiment of matching an advertiser with a golf course hole in accordance with the method of FIG. 1.

FIG. 5 is a flowchart illustrating one embodiment of matching an advertiser with a golf course hole in accordance with the method of FIG. 1.

FIG. 6 is a flowchart illustrating another aspect of the inventive method shown in FIG. 1.

### DETAILED DESCRIPTION OF THE DRAWINGS

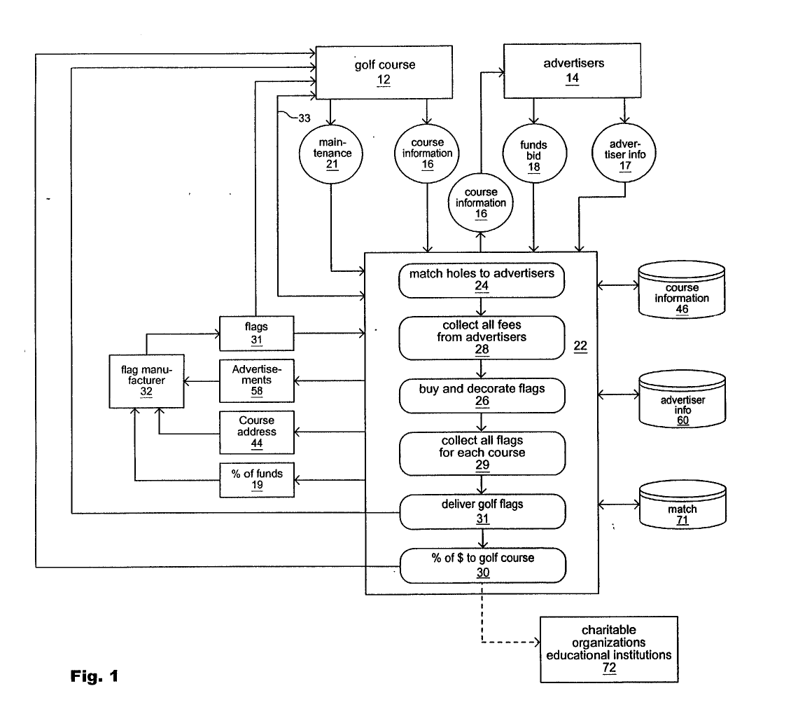

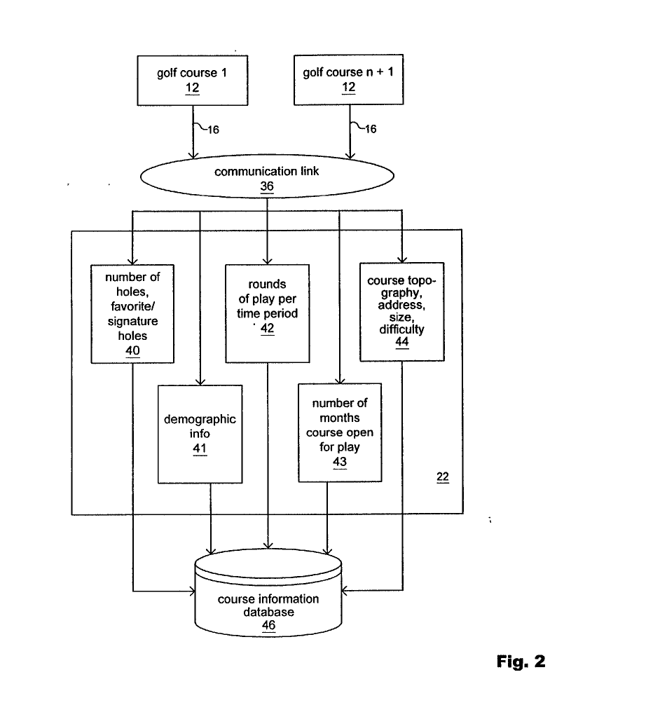

FIG. 1 illustrates the inventive method of the present invention including the use of flags, which mark holes on a golf course 12 and are decorated with advertising, and the participating advertisers who provide the flags for the golf course in return for the right to use advertising, such as logos, taglines, trademarks, website addresses, mottos, telephone numbers and the like on the flags. FIGS. 2-6 illustrate various aspects of the method shown in FIG. 1.

Referring to FIGS. 1-6, a method allows a flag provider or business administrator 22 to manufacture and deliver such decorated flags to golf courses, which are preferably public or semi-private or private with amateur or professional players, at no cost to these courses. The method starts by the flag provider 22 soliciting advertisers 14 including companies, organizations, or other entities that seek high-profile advertising such as the golf environment. The companies are offered the opportunity to use its advertisement selected from logos, trade names, websites, mottos, such as the famous Nike's “Just do it” and combinations of these by providing funds 18 in exchange for advertising space on the flags. The selected advertisers 14 may rent the advertising space for a predetermined period of time 56, such as a single season, or alternatively, can become flag site owners by providing funds on a regular basis or in a lump sum manner.

As indicated above, the process provides business cooperation between the golf course 12 having a plurality of holes, which are marked by flags serving as an advertising medium, and multiple advertisers 14 funding the golf course for the right to have their advertising on the flags. The course information 16 received by the flag provider 22 from the selected golf course 12 includes the number of holes and favorite or signature holes 40, demographic information of course users 41, the rounds of play per time period 42, the number of months the course is open for business 43, course topography, address, size and difficulty 44, as shown in detail at FIG. 2. This information is compiled in a course information database 46.

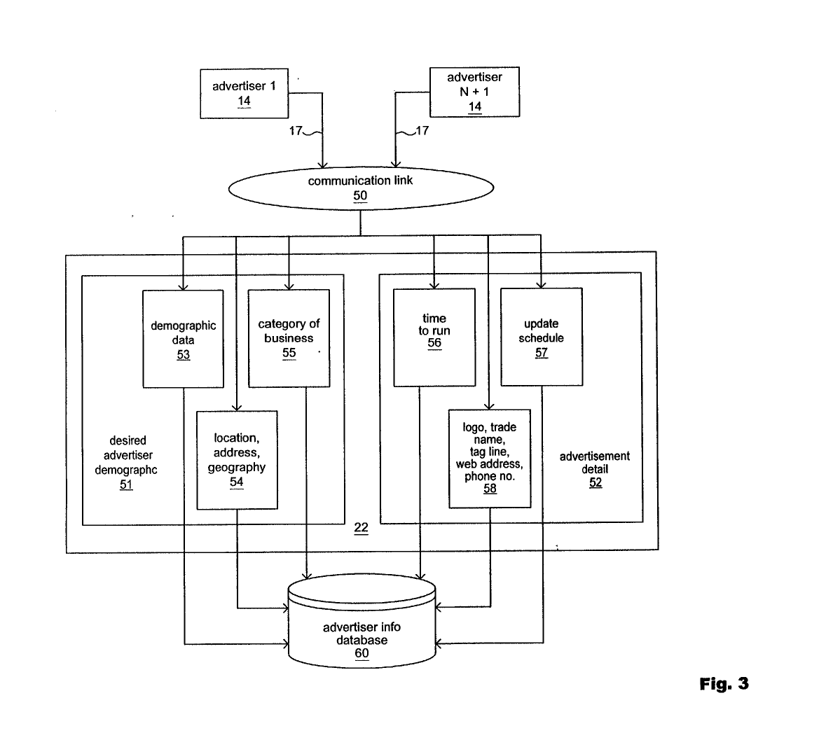

Additionally, as shown in detail at FIG. 3, the advertiser information 17 received by the flag provider 22 from the selected advertisers 14 includes the desired demographic data 53, geography 54, category 55, time to run 56, update schedule 57, and the appropriate logo, trade name, tag line, web address or phone number 58. Advertiser information may be considered in two sub-groups where the desired advertising demographic 51 includes the demographic data 53, geography 54, category 55 information and the advertisement detail 52 includes the time to run 56, update schedule 57, and the appropriate logo, trade name, tag line, web address or phone number 58. The advertiser information 17 is compiled in an advertisers information database 60.

Category information 55 is included as part of the advertiser information 17 to ensure that a duplication of category of advertiser does not occur on a course where exclusivity has been offered to an advertiser of a specific category of product.

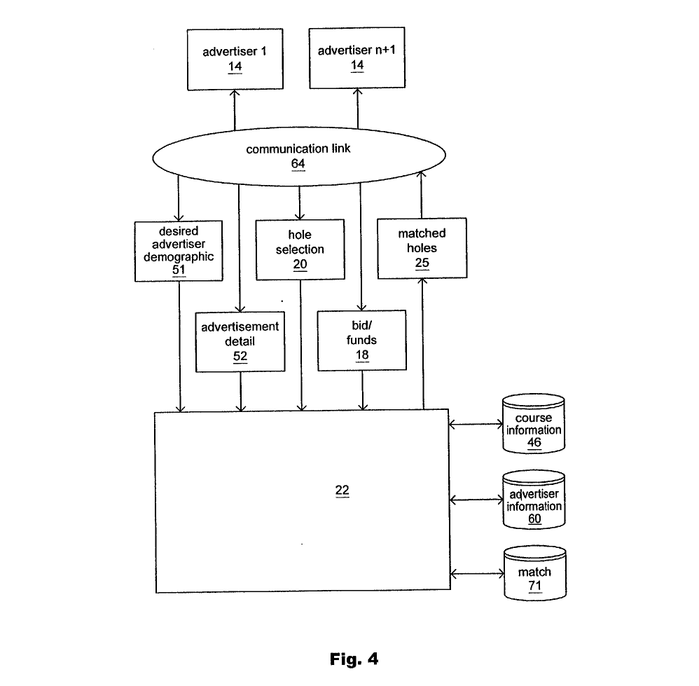

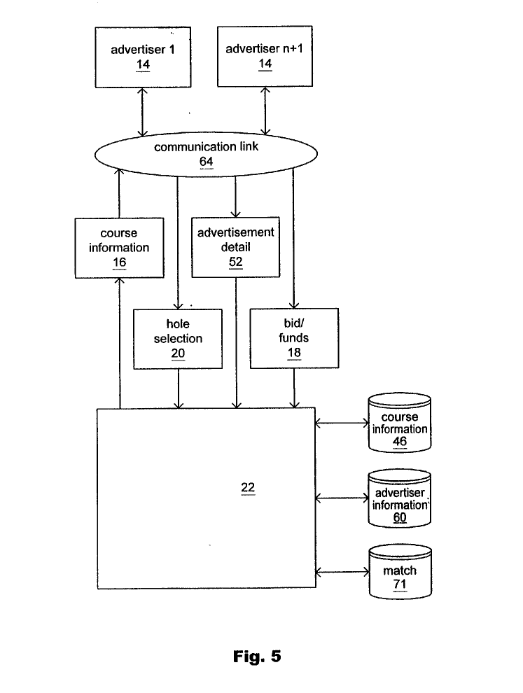

The flag provider will accumulate the course information 16 either by publicly available databases or from direct communication 36 with golf course administrators as shown in FIG. 2. The course information can be processed by the flag provider, in combination with the collected advertiser information 17, to match course holes with suitable advertisements, as illustrated in FIG. 4. FIG. 5 illustrates an application of the method where the course information 16 is supplied to a participating advertiser by the flag provider, which can in turn select course holes for its advertisements.

It is also envisioned that combinations of flag provider 22 and advertiser 14 inputs would result in a match. For example, the flag provider may arrive at several matches for a participating advertiser. The advertiser could then request the specific course information 16 pertaining to the potential matched holes. The advertiser could then choose from among those course holes selected by the flag provider the course holes in which it wishes to place advertisements.

Golf courses 12 that provide more detailed course information 16 to the flag provider 22 than is publicly available may be given priority in the matching process. Such detailed information includes more specific demographic information 41 or favorite and signature holes information 40 and provides the flag provider with a more complete database and an advantage in attracting advertisers. Golf courses 12 seeking funds to improve the care of their facilities by offering their golf course accessories as an advertising medium may similarly be selected in advance if they provide the flag provider with more detailed course information. As a result, these courses could be given priority in the matching process.

As the necessary golf course information is being gathered, the flag provider communicates with multiple advertisers 14 regarding purchasing the rights to place their advertising on a specified number of flags. A participating advertiser could then supply the flag provider with the relevant advertiser information 17, including the desired advertising demographic 51 and the advertisement detail 52 as illustrated in FIG. 3. Alternatively, a potential advertiser could request from the flag provider course information 16 for the purposes of selecting matching holes.

Advertisers 14 that provide advertiser information 17, specifically the advertisers' desired advertisement demographic 51, to the flag provider 22 offers an additional advantage to the flag provider. The desired advertisement demographic 51 supplies the flag provider with valuable demographic information resulting in a more complete advertiser database 60 and a greater ability to attract golf courses. Accordingly, these advertisers may be given priority in the matching process.

An advertiser who chooses to review the course information and select course holes may be presented with a listing of participating golf courses. The information relating to the golf courses presented to the advertiser can vary from a limited disclosure of the accumulated course information to the entire course information the flag provider has regarding the particular courses, depending on the particular agreements reached by the parties. The course information conveyed to the advertiser could further include a brief analysis of the area surrounding a desirable course and including industrial, political and social aspects associated with this area.

A participating advertiser wishing to purchase advertising rights based on the course information 16 provided by the flag provider, may use its own criterion to choose a suitable hole, or use such factors as choosing flags associated with a course's favorite or signature hole, as indicated at 40.

In addition to the course information submitted at 16 in FIG. 2, the golf course may, depending on local laws and regulations and/or golf course administration preferences, have requirements limiting the access of potential advertisers to available advertising medium. The flag provider, in order to avoid conflict with certain demands by golf courses and/or to provide the most suitable advertising medium for advertisers, may use a stricter criterion for matching in addition to directly matching advertisers to holes. Thus, golf courses located in areas where a population has well-expressed political or philosophical sentiments may be a better or worse advertising target for a particular business. As an example, tobacco and/or gun-manufacturing businesses may be welcome by golf courses in one geographic area, whereas public golf courses located in another area may not welcome products of these businesses. Furthermore, manufacturers of garments that are known for their fall and winter collections will be better suited to purchase rights to advertise their products at golf courses located in Northern States.

The flag provider 22 receives information from participating advertisers indicating the course holes selected 20. If the hole is available, the match is completed 24 (FIGS. 1 and 5). If the selected hole is not available, a bidding 70 opportunity occurs. The flag provider continues this process until all of the holes on the selected golf course are purchased. This information is compiled in a match information database 71.

As an example, assuming that each of the advertisers 14 has a right to purchase “two holes”, the flag provider 22 continuously communicates 64 with the advertisers until a pool of nine advertisers is completed. It is preferred that each advertiser 14 can obtain the rights for placing its advertisement on two flags, thus acquiring rights for two holes. However, it is envisioned that a varying number of flags carrying advertisements of the same advertiser may be purchased on a course.

Whether the procurement of advertisers occurs with the flag provider matching the advertiser and golf course hole, or by the advertiser selecting the matching course holes, or a combination thereof, at the time of matching, the flag provider is in possession of all necessary information submitted by the golf course and advertisers. Preferably, this information includes at the least the advertiser detail 52.

As mentioned above, the matching continues until all of the holes of the golf course are sold out. Collecting funds 18 (FIG. 1) for the sold holes may occur simultaneously with the matching step. Preferably, however, advertisers 14 pay endorsement funds 18 and provide prototypes of the advertising at 58 (FIG. 3) to the flag provider 22 after all of the holes of the given golf course have been distributed, as shown at FIG. 1.

Upon collection of the fees 28, the flag provider, using funds 18 received from the advertisers 14 in return to the acquired rights, purchases and decorates the flags 26, and collects all flags for each course 29. In practice, the flag provider 22 need not provide all of the services itself. The flag provider can transfer the flag request, including the selected advertisement 58 and golf course locations 44 (FIG. 1), to a flag manufacturer 32 or other third party for manufacturing, decorating and delivering the ordered flags. The flag provider would compensate the manufacturer 32 or third party for their services using a percentage of the funds 19 received from the advertisers 14. By contracting the third parties for certain services, the flag provider 22 is able to reduce costs and more effectively promote the growth of the method. Advantageously, the flag manufacturer is located in the vicinity of the golf course to facilitate delivery of the decorated flags by any known means of transportation. Furthermore, the flag manufacturer preferably has a capability of decorating the manufactured flags with the advertising. It is understood that a variety of decorating methods such as silk screening, sewing, embroidery, photography, holographic techniques and the like can be successfully implemented.

The flag provider is then responsible for all the service requirements in regard to the decorated flags including replacement of the flags in response to requests 21 by the golf course. The first delivery of the flags may include two identically decorated flags for each hole as a matter of maintenance, convenience, advertising programs and the like. Then, the golf course administration may inform the flag provider at 33 (FIG. 1) that one of the flags has just been replaced, which would initiate communication between the flag provider and the flag manufacturer to manufacture and deliver a new set of requested flags. Otherwise, the flag provider may contract the flag manufacturer to deliver the decorated flags on a periodic basis. These service requirements are paid for using a percentage of the funds 19 received from the advertisers 14. Therefore, the golf course administration 12 need not incur any costs in acquiring and maintaining the decorated flags.

The flag provider may pay a certain percentage 30 (FIG. 1) of the funds received from the advertisers to the golf course. The flag provider 22 may further attract and entice golf courses by providing a portion of funds to charitable organizations and educational institutions located around the golf course, as shown at 72 in FIG. 1.

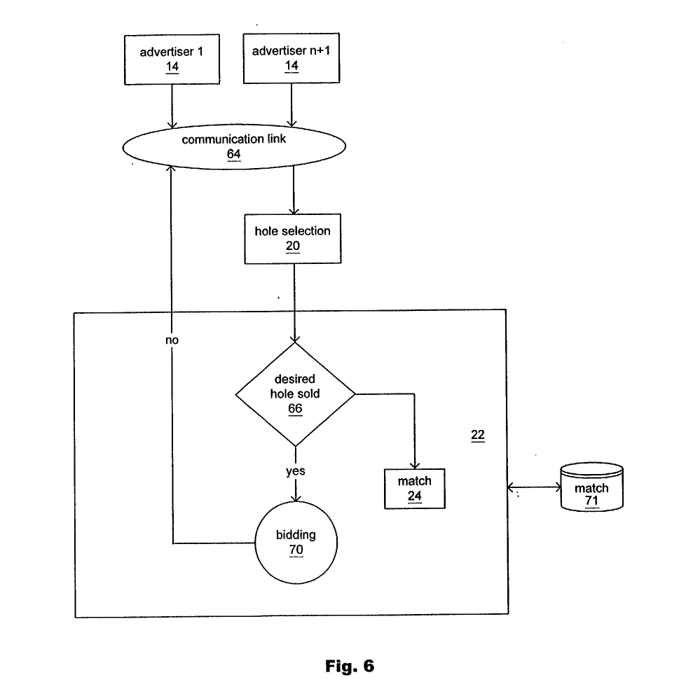

Once a selected hole and an advertiser are matched, the flag provider 22 checks the availability of the hole to see if any other advertiser has requested the same hole. If the hole is available, the information is stored in the match database 71 and the method is continued as described above. If multiple advertisers express an interest in acquiring the rights associated with the same hole, the flag provider can arrange bidding, as seen at 70 in FIG. 6.

The method, as disclosed above, can be implemented by any communication link including telephone or by employing an automated system as the number of participants increases. One of the automatic implementations may include a computer with information processing and storage capabilities and electronic communication connections that permits the flag provider 22 to electronically connect to third parties, such as the advertisers and golf courses. It is also envisioned that communication between the automated system and third parties can be provided via a communication link 36, 50 and 64 (FIGS. 2-6) which may be telephone lines, the Internet, or any other communication medium. As information is gathered, the automated system will allow software executing in the computer to automatically receive and store the acquired data.

In particular, the course information 16 received from the golf courses 14 via a communication link 36, as shown in FIG. 2 can be received by software executing on the computer. Furthermore, the system can have a storage facility or course information database 46 with software executing in the computer that can systemize, store and retrieve the received information. The course information database 46 is accessible by the computer and may be utilized by software executing in the computer for conducting the matching step 24, as shown in FIG. 1.

Similarly, as the advertisers communicate with flag provider through the communication link 50, software executing in the computer receives and processes the advertiser information 17 as shown in FIG. 4, stores this information in an advertisers information database 60. The advertisers information database 60 is accessible by the computer and may be utilized by software executing in the computer for conducting the matching step 24, as shown in FIG. 1.

It is further envisioned that software executing on the computer can perform the search for flag manufacturers and all financial transactions. Furthermore, the bidding step as shown in FIG. 6, can be also performed by software executing in the computer.

Although the invention has been described with reference to a particular arrangement of features and the like, these are not intended to exhaust all possible arrangements or features, and indeed many other modifications and variations will be ascertainable to those of skill in the art.

What is claimed is:

1. A method for providing flags decorated with advertising to at least one golf course comprising the steps of:
receiving funds and advertisements from advertisers;
manufacturing and decorating at least one flag with an advertisement associated with each of said advertisers using said funds; and
delivering the decorated flags to the at least one golf course using said funds.

2. The method defined in claim 1 further comprising the steps of receiving the information about the at least one golf course including a number of holes, and matching advertisers selected to purchase the rights to decorate the flags with advertising in return for providing said funds for the holes.

3. The method defined in claim 1 further comprising the step of paying the one golf course a portion of funds received from said advertisers.

4. The method defined in claim 1 further comprising a step of contracting a third party for manufacturing and decorating the flags using the funds provided by the advertisers.

5. The method defined in claim 2, wherein the information received from the one golf course further includes an address, a topographical profile, and a set of requirements selectively precluding the advertisers from obtaining the right to purchase the right to decorate the flags with the advertising.

6. The method defined in claim 5 further comprising the steps of obtaining information from each of the advertisers including a nature of business, address, hole preferences, and matching the holes to the advertisers by processing the information obtained from the one golf course and the advertisers.

7. The method defined in claim 6 further comprising the steps of identifying multiple advertisers willing to purchase the right to use advertising on flags which mark the same hole on the one golf course, and providing bidding between the identified advertisers.

8. The method defined in claim 1 further comprising the step of providing the one golf course with new decorated flags in response to a request submitted by the one golf course upon its inspection of the installed decorated flags.

9. The method defined in claim 1 further comprising the step of providing charitable organizations and public educational institutions located in the vicinity of the one golf course with a percentage of the funds from the advertisers.

10. A method for providing flags decorated with advertising to at least one golf course comprising the steps of:
gathering golf course information including a number of holes of the at least one golf course;
matching multiple advertisers willing to purchase the rights to place their advertising on flags which identify holes on the at least one golf course in return for submitting endorsement funds;
receiving the funds and advertising from advertisers;
manufacturing and decorating at least one flag with an advertisement associated with each of said advertisers using said funds;
delivering the decorated flags to the at least one golf course using said funds; and
paying a percentage of the funds received from advertisers to the at least one golf course.

11. The method defined in claim 10 further comprising the step of collecting data including course topography, course size, course difficulty, and number of visitors in addition to the course information.

12. The method defined in claim 11 wherein said collected data further includes requirements selectively precluding the advertisers from obtaining the right to purchase the right to decorate the flags with the advertising based on the nature of business.

13. The method defined in claim 10 further comprising the step of recording information data from the one golf course and submitting the data to the multiple advertisers.

14. The method defined in claim 10 further comprising the step of procuring the multiple advertisers willing to purchase the rights on decorating the flags with the advertising in return for distributing the data from the one golf course, wherein the advertising is selected from the group consisting of a logo, trade name, web address and motto and combinations of these.

15. The method defined in claim 10, wherein the step of decorating the flags is performed by a method selected from the group consisting of sewing, embroidery, holography and photography.

16. A method for providing flags decorated with advertising to at least one golf course comprising the steps of:
procuring advertisers willing to purchase the rights to place their advertising on flags which identify holes on the one golf course in return for submitting endorsement funds;
receiving the funds and advertising from the procured advertisers;
manufacturing and decorating at least one flag with an advertisement associated with each of said advertisers using said funds; and
delivering the decorated flags to the at least one golf course using said funds.

17. The method defined in claim 16 further comprising the step of obtaining information from the one golf course including a number of holes, address, number of visitors, topography, preferable hole selection and a set of requirements which selectively precludes the advertisers from obtaining the right to purchase the right to decorate the flags with the advertising.

18. The method defined in claim 16 further comprising the steps of collecting information from the procured advertisers, the advertiser's information including an address, nature of business, and hole preferences, and matching the holes to the procured advertisers upon processing the information from the procured advertisers and the one golf course.

19. The method defined in claim 16 further comprising the steps of identifying multiple advertisers willing to purchase the right to use advertising on flags which mark the same hole on the one golf course, and providing bidding between the identified advertisers.

20. The method defined in claim 16 further comprising the step of providing the one golf course with a percentage of funds received from the advertisers in return for the right to decorate the flags with the advertising.

21. A system for providing flags decorated with advertising to at least one golf course comprising:
a host operated processing system (PS), said PS being a computer having information processing and storage capabilities and electronic communication connections;
golf course information received by the PS, said golf course information being indicative at least of a number of holes on the one golf course;
advertiser information received by said computer and being indicative of identifying advertisers who are willing to purchase the rights to place their advertising on flags which identify holes on the one golf course in return for submitting funds;
software executing on the computer for matching the holes to the identified advertisers; and
means for delivering flags decorated with the advertisement and a percentage of the funds to the one golf course administration.

22. The system defined in claim 21, further comprising a communication link between the computer and the one golf course and between the computer and the advertisers.

23. The system defined in claim 21, further comprising a database accessible by the computer and storing the information pertaining to the one golf course and to the multiple advertisers, wherein said data being maintained as one of a plurality of records of said database.

24. The system defined in claim 21 further comprising software executing on the computer for automatically placing an order to a selected flag manufacturer after the rights have been sold on all of the holes of the one golf course, said flags being decorated with the advertising unique to each of the identified advertisers and selected from the group consisting of logos, trade names, web addresses and mottos and combinations of these.

25. The system defined in claim 21 further comprising software executing on the computer for automatically calculating the percentage of paid fees received from each advertiser after all of the holes of the one golf course have been paid for.

26. The system defined in claim 21 further comprising software executing on the computer for identifying a plurality of advertisers willing to purchase the rights for the same hole, and software executing on the computer for providing bidding between the identified advertisers.

27. The system defined in claim 21 further comprising software executing on the computer for calculating another percentage of the paid fees to sponsor charitable organizations and educational institutions located in the vicinity of the one golf course.

28. The system defined in claim 1, further comprising software executing on the computer for utilizing criteria for assessing the advertisers with the required fee which is selectively established by the computer based on the advertisers' records and on the one golf course's record stored in the database.
